(19) United States
(12) Patent Application Publication
(10) Pub. No.: US 2012/0136726 A1
(43) Pub. Date: May 31, 2012

(54) METHOD AND APPARATUS FOR INTERACTING WITH A USER OVER A NETWORK

(75) Inventor: Robin Caller, London (GB)

(73) Assignee: GOALLOVER LIMITED, London (GB)

(21) Appl. No.: 13/321,472

(22) PCT Filed: May 18, 2010
(86) PCT No.: PCT/GB10/00985

§ 371 Date: Feb. 13, 2012

Related U.S. Application Data
(60) Provisional application No. 61/179,637, filed on May 19, 2009.

(51) Int. Cl. G06F 15/16; G06Q 30/02

(52) U.S. Cl. 705/14.66; 705/14.4; 709/203

(57) ABSTRACT

A method for a server to interact with a user machine over a network, the method comprising the server receiving user information from the user machine in response to injected content received by said user machine; validating the user information in real-time to produce a validation result; and writing a cookie to the user machine as part of a confirmation page for the user information, said cookie indicating said validation result.

### FIELD OF THE INVENTION

The invention relates to a server interacting with a user machine over a network such as the Internet.

### BACKGROUND OF THE INVENTION

It is very common for organisations to interact with clients over the Internet, in particular via the worldwide web (the term “client” is used generically here, rather than necessarily implying any existing commercial or business relationship). Examples of such interactions include the supply of goods or services (e.g. on-line shopping, booking of travel arrangements, etc), the provision of information (e.g. news sites, search sites, etc), the acceptance of donations or other forms of support (e.g. a charity site), the collection of data from people (e.g. on-line surveys and voting), and so on.

In such interactions, it is common for the web-site of the organisation to leave a cookie on the client machine. The cookie identifies the client machine in future to the organisation, thereby helping the organisation to maintain a record of interactions involving the client machine.

One use of the Internet is to generate leads that represent potential clients of the future. WO 2008/093062, which is incorporated herein by reference, discloses a system for generating such leads through the use of interstitial pages. An interstitial page is where a user activates a link to request a particular page but is directed instead to an intermediate page. The interstitial page may be provided by the party hosting the original link or by the party hosting the requested page, or by some other entity acting on behalf of (or in combination with) one of these two parties.

The interstitial page usually requests some form of input from the user. For example, an interstitial page might be used to collect information from the user for a variety of purposes, including on-line surveys, the identification of marketing prospects, etc. After the input has been provided (or if the user explicitly declines to provide such information), the user can then be forwarded to the originally requested page.

It is common practice to drop a cookie on the client machine after receiving input from the user for an interstitial page. The cookie confirms that the user has received and responded to the relevant interstitial page. This information can be used in the future when deciding what interstitial page to serve to the client. For example, if the cookie indicates that the client has already completed a particular on-line survey, there is usually no point in providing the same survey again to the client. Likewise if the client has indicated no interest in a particular product, it may be better to provide them next time with an interstitial page relating to a different product. Alternatively, it may be appropriate to provide the user with an interstitial page containing an (increased) incentive relating to the original product, for example a link to a money-off coupon.

The interstitial page frequently requests the user to provide personal identification information, for example, name, address, telephone and email. There are various reasons for wanting to collect such information. For example, a survey may want to confirm that it has received input from a suitable geographical range of clients, while a sales department may want to pursue the client as a possible marketing lead. Data sets of user information obtained in this way therefore have commercial value, and are frequently the subject of various business arrangements.

In one common configuration, there are three parties involved. The first is the party who redirects the client to the interstitial page. Such a party is often a content provider who has a high volume of traffic on their web site. The second party is the organisation that selects the content of any given interstitial page to be delivered to the user and collects the data from the user via the interstitial page. In certain contexts, the second party may considered as an ad server. The third party is the organisation that wants to acquire the user data, for example an advertiser or sales organisation. The third party may provide the second party with the content for use on the interstitial page to collect the user data. In this configuration, the second party typically pays the first party to host the advertisements or other desired content, while the third party typically pays the second party for each set of user information obtained. Another possible arrangement is for the third party to pay the first party for each set of user information, and a fee to the second party for serving the relevant content.

Although the above model is now commonplace on the Internet, one problem is that a certain proportion of user data collected is invalid. For example, users may accidentally or (quite frequently) deliberately provide incorrect or inaccurate information about themselves. In many cases the party paying to acquire the user data receives (and indeed pays for) such invalid data, despite the fact that this data is of no commercial value.

In some case the user data may be validated after collection, for example by checking that the street address of a user corresponds properly with the post code. However, to date such validation has tended to be rather cumbersome and ineffectual.

### SUMMARY OF THE INVENTION

A method for a server to interact with a user machine over a network, the method comprising the server:

receiving and storing user information from the user machine in response to injected content received by said user machine;

validating the user information in real-time to produce a validation result for accepting the stored user information; and

writing a cookie to the user machine as part of a confirmation page for the user information, said cookie indicating said validation result.

Note that the validation and validation result relate just to the user information supplied, rather to any financial or other transaction (such as a credit card payment) involving the user information. The injected content generally comprises a banner ad, an interstitial page, or such-like, and may be provided in response to a request for a specified page at a publisher web-site. In some cases the injected content may include a form for allowing a user to enter the user information. In other cases the injected content may link to a form for allowing a user to enter the user information.

In one embodiment, the validation result cookie is obtained prior to providing the user machine with further injected content. The validation result cookie can then be used for determining what further injected content to provide to the user machine.

In one embodiment, the confirmation page allows an ad server to write a cookie to the user machine. The ad server cookie indicates the validation result and is obtained by the ad server prior to supplying further injected content to the user machine. This allows the ad server cookie to be used to determine which further injected content to supply to the user machine. For example, in response to obtaining a particular validation result cookie from a user machine, the ad server may not provide the user machine with the injected content that led to that validation result cookie.

In one embodiment, if validating the user information in real-time produces a negative validation result, the user machine may be prompted to provide amended user information. The amended user information can be validated in real-time to produce an updated validation result, and the cookie written to the user machine can indicate this updated validation result.

Another embodiment of the invention provides a method for pre-duplication avoidance comprising:

receiving user information from the user machine in response to injected content received by said user machine;

validating the user information in real-time to produce a validation result;

writing an ad server cookie to the user machine as part of a confirmation page for the user information, said cookie indicating said validation result;

detecting said cookie at the user machine in the future by said ad server; and

using the detected cookie to determine further injected material to provide to the user machine.

The invention further provides a server and a computer program for performing any method as described above.

Existing systems may leave a cookie on a client machine indicating which content has been presented to the client machine, and also the nature of the client response to such content. This cookie can then be used to help future targeting to that client. The present approach improves on such an approach, in that the user data received from such a client machine is validated in real-time (i.e. while the client is still interacting with the relevant web site). The cookie provided to the client machine can then be used to indicate the result of the validation of the user data, which in turn can further improve future targeting, for example in relation to injected content such as banner advertising or an interstitial page.

The validation may be performed using a validation system that involves learning from previous sets of user-data that have been subject to human review in respect of their validation status. In particular, the validation system is configured to update criteria for validation on the basis of new validation results.

The approach described herein also provides a method and apparatus that will scan and query multiple aspects of consumer data sets to filter these data sets and produce a real time “validation” of these data sets. This enables the placement of cookies in order to empower pre-duplication (and not just post serving de-duplication) of data sets. The filtering algorithm can be iteratively enhanced by multiple operators and ubiquitous computing practices.

The present invention also provides an apparatus and computer program for implementing a method such as described above. The apparatus may comprise one or more computer systems under suitable program control. The computer program may comprise instructions in machine-readable form which when loaded and executed by one or more computer systems cause the computer systems to implement the method of the invention. The computer program may be provided as a computer program product, with the instructions stored on a medium such as a CD, DVD, flash ROM, etc, or supplied using a transmission medium such as the Internet.

### BRIEF DESCRIPTION OF THE DRAWINGS

Various embodiments of the invention will now be described in detail by way of example only with reference to the following drawings:

FIG. 1 illustrates a computer network in accordance with one embodiment of the invention;

FIG. 1A illustrates a computer network in accordance with another embodiment of the invention;

FIG. 2 illustrates a flowchart for a method of providing an interstitial page to a user;

FIG. 2A illustrates a flowchart for a method of providing banner advertising to a user;

FIG. 3 illustrates an example of an interstitial page provided in accordance with one embodiment of the invention;

FIG. 4 is a flowchart illustrating the handling of cookies in accordance with one embodiment of the invention;

FIG. 5 is a flowchart illustrating the selection of an interstitial page in accordance with one embodiment of the invention.

FIG. 6 is a diagram illustrating certain components involved in user validation according to one embodiment of the invention.

FIG. 7 is a flowchart for updating the validation procedure in accordance with one embodiment of the invention.

### DETAILED DESCRIPTION

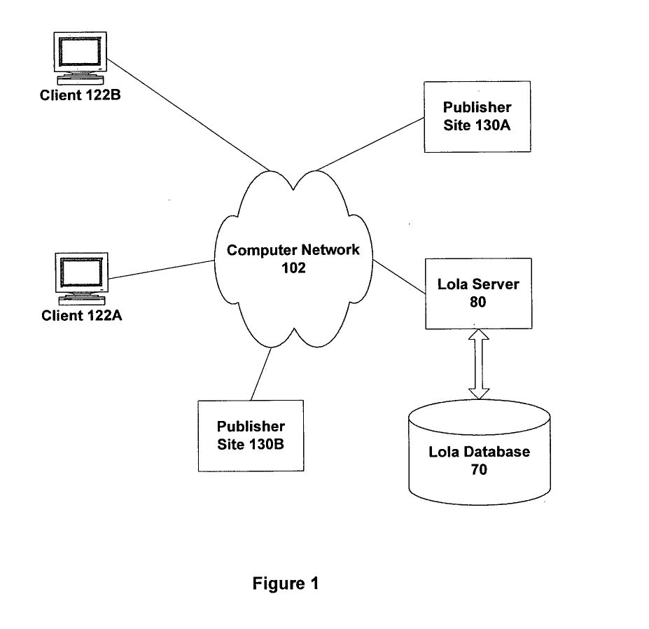

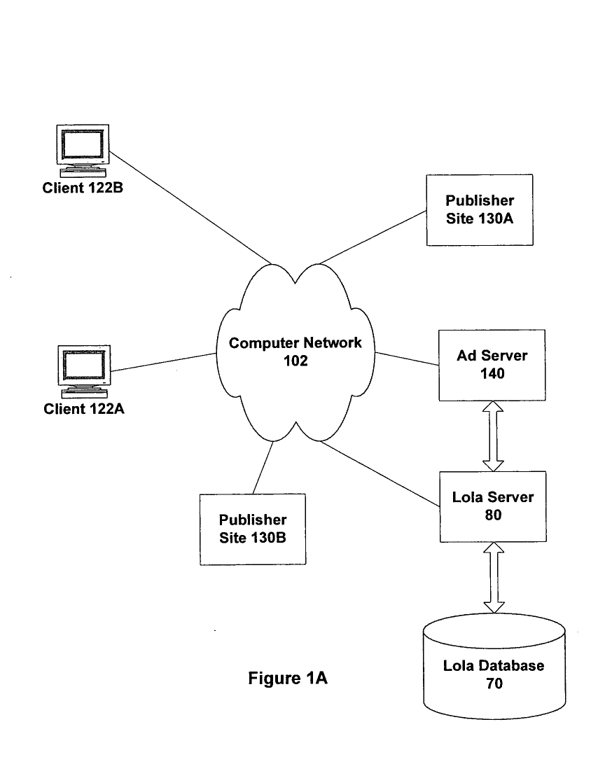

FIG. 1 illustrates various computer systems linked by a data network in accordance with one embodiment of the invention. In particular, FIG. 1 depicts the web-sites 130A, 130B of two publishers that may be accessed over computer network 102. Each web-site may be implemented by a server, a server cluster etc. Each web-site may be run directly by the publisher, or may be hosted by some third party, such as an application service provider, on behalf of the publisher. Note that publisher is used here in a general (broad) sense to indicate any organisation that makes information available over the network, and may include media companies, retailers, educational institutions, etc.

The content on the publisher web-sites 130A, 130B may be accessed by clients 122A, 122B over network 102. In one embodiment, clients 122A, 122B are conventional personal computers provided with a web browser such as Internet Explorer from Microsoft Corporation, and computer network 102 comprises the Internet (worldwide web). However, clients 122A, 122B may comprise any suitable data device, including a digital television, a PDA or other portable computer device, a mobile telephone (cellphone) with support for data access, etc. In addition, client device 122 may access a publisher web-site 130 via any suitable network(s), such as the Internet, a mobile telephone network, a digital television network, etc.

FIG. 1 also illustrates a server 80, denoted in FIG. 1 as the Lola server 80. The Lola server 80 is provided with a database 70, which may be local or remote to server 80. In one embodiment, database 70 comprises a Microsoft SQL database, while the Lola server 80 is based on the .NET platform (also available from Microsoft Corporation). However, it will be appreciated that any other suitable database and/or application platform could be used instead.

The Lola database 70 is used to store various information received by the Lola server. The Lola server 80 and database 70 may be implemented by one or more machines as appropriate. The Lola server 80 is generally able to communicate with clients 122 over the same computer network 102 as publisher web-sites 130. In addition, the Lola server can communicate with the publisher web-sites 130 over computer network 102. In some embodiments, the Lola server 80 and database 70 may be provided with separate (or additional) communications to a publisher web-site (rather than using computer network 102). In some embodiments, the Lola server 80 and database 70 may in effect be integrated into a publisher web-site 130.

In general, the skilled person will be aware of a wide range of possible modifications to the configuration shown in FIG. 1. For example, it will be appreciated that while FIG. 1 depicts only two clients and two publisher web-sites, the number of clients and the number of publisher web-sites will generally be much larger than two. In addition, publisher web-sites 130A, 130B and/or server 80 may be accessible to a wide range of client devices via multiple different networks.

FIG. 1A illustrates various computer systems linked by a data network in accordance with another embodiment of the invention. The configuration of FIG. 1A is generally similar to that of FIG. 1, except for the additional presence of ad server 140. Thus when a user contacts a publisher site 130 for a content page, the publisher site interacts with the ad server 140 which provides a banner ad for display on the content page. The ad server 140 may supply the advertisement directly to the client 122 (in effect the content page supplied by the publisher site 130 includes a link to the ad server site 140). Alternatively, the ad server 140 may provide the advertisement to the publisher site 130 for inclusion in the content page supplied by the publisher site to a client 120.

As shown in FIG. 1A, the Lola server 80 is able to communicate with ad server 140, through computer network 102 and/or through a customised link. In the embodiment of FIG. 1A, the Lola server generally interacts with the publisher sites 130 via the ad server 140, rather than directly (as for the embodiment of FIG. 1). It will be appreciated that there may be multiple ad servers 140, and the Lola server interacts with different publisher sites through different ad servers. A further possibility is that the Lola server interacts directly with some publisher sites, and interacts indirectly through one or more ad servers with other publisher sites.

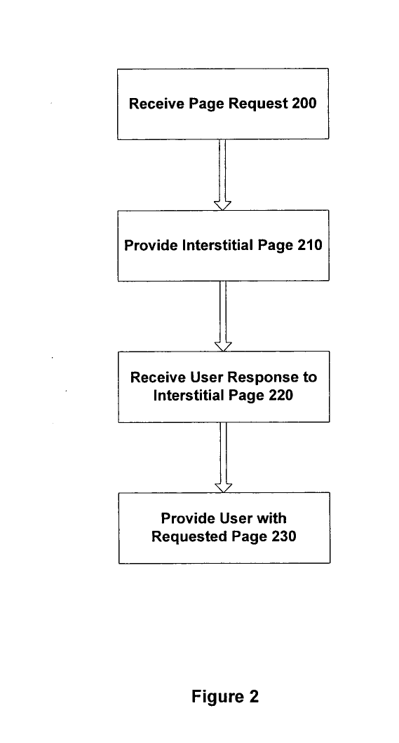

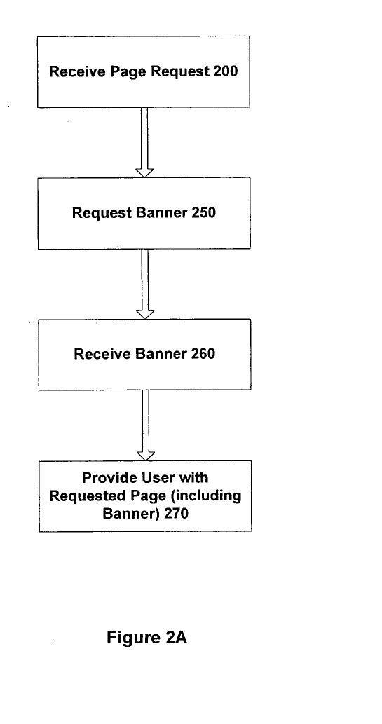

FIG. 2 is a flowchart illustrating certain operations of the various computer systems of FIG. 1 and/or FIG. 1A. In operation 200, a publishing web-site 130 receives a request from a user (client 122) for particular content. For example, a user requests a particular web page that resides on the publisher web-site by sending an http request to the publisher web-site specifying the URL of the requested page. The requested web page may comprise any particular content—e.g. text, images, video, animation, audio, applets, etc. In addition, the requested page may represent an existing (static) page, or a dynamic page that is to be assembled or generated by the publisher web-site in response to the particular user request (URL). In many situations, the user will already be accessing material from the publisher web-site, so the request of operation 200 will commonly comprise the user selecting a hyperlink within the previously provided material, where the hyperlink specifies some other page on the publisher web-site.

However, rather than the publisher web-site directly providing the requested material to the client browser, at operation 210 an interstitial page is provided to the client instead. In this context, interstitial implies that the material is inserted into a sequence of web pages received by the client. In other words, by submitting the request at operation 200, the user is expressing a desire to move from an original page (which might be the user's startup or home page, another page on the publisher web-site, or some third party page, for example a search engine or directory) to the requested page. The interstitial page is provided to the user as they leave the original page, but before they receive the next requested page—i.e. the page that the user has requested to follow directly the original page. Accordingly, the interstitial page is not part of the normal flow of web pages for a site, but rather is injected into the sequence of pages requested by the user.

The mechanism for providing the interstitial page to the user may vary according to the particular implementation. In one embodiment, the interstitial page is provided to the client 122 by the Lola server 80. This is accomplished by having the publisher web-site 130 forward the client browser 122 to the Lola server 80 (using the http re-direct facility). In another embodiment, the interstitial page is provided to the client 122 by the publisher web-site itself. This may involve the publisher web-site integrating (or interacting with) the Lola server 80, either directly (as for the embodiment of FIG. 1), or indirectly through ad server 140 (as for the embodiment of FIG. 1A). A further possibility is that the publisher returns a shell or blank interstitial page to the client, and this blank page then pulls in content from the Lola server 80.

The user provides a response to the interstitial page at operation 220. This response may include user information which can then be stored into the Lola database 70. The user can then be re-directed to the web page that they originally requested at operation 230.

The decision as to whether or not to provide the interstitial page to the user (instead of the requested page) at operation 210 is generally made by the publisher web-site that receives the request at operation 200. Another possibility is that the decision is made by ad server 140, which has an arrangement to supply advertising material to publisher web-site 130. The decision as to what content to put into the interstitial page (if served) is normally made by the Lola server 80 or the ad server 140 (if utilised). Various criteria for making such decisions on what (if any) interstitial page to provide, along with further details on the systems shown in FIGS. 1 and 2, are provided in the above-mentioned WO 2008/093062, which is incorporated herein by reference.

In addition to the provision of interstitial pages, the Lola server 80 may also be to used for banner advertising and the like. A banner advert is provided to a user for display on the same screen as the requested content, for example as a banner across the top of the page (hence the name). The banner advert may be injected onto the page by a third party provider, such as Doubleclick (acquired by Google in 2007).

The banner advert generally provides an advertising message (e.g. text, image or animation) in respect of a product or service. The banner advert also acts as a link to a web-site run by the advertiser, so a user can click on the banner advert if they want to proceed further in respect of the advertised product, for example, to make a purchase or to acquire more information.

FIG. 2A is a flowchart illustrating the provision of a banner advert, for example using the systems shown in FIG. 1 or FIG. 1A. The processing is triggered by a user page request to a publisher web-site 130 at operation 200. The publisher web-site may, in response to such a client input, transmit a request for banner content to the Lola server at operation 250, either over network 102 or some other link (not shown in FIG. 1A). The Lola server 80 returns the banner content at operation 260 (after interaction, if required, with ad server 140). The publisher web-site then returns the requested page (including banner) to the client 122 at operation 270.

It will be appreciated that there are a number of possible variations on the operation sequence shown in FIG. 2A. For example, rather than returning the banner content itself in operation 260, the Lola server may just send a link or reference to this content. The publisher web-site then includes this link in the page returned to the client, and the client browser subsequently contacts the Lola server itself to retrieve the banner material for display in the page. A further possibility is that publisher web-site does not contact the Lola server 70 at all (i.e. operations 250 and 260 are omitted) but just includes a (predetermined) link to the Lola server in the page provided to the client in response to the page request at operation 200. The client browser then follows this link to the Lola server to obtain the content for the banner when displaying the requested page.

A further possibility is that the Lola server 80 is not directly involved in the provision of the banner advert to the client. Rather, a publisher web-site 130 may make its own decision as to which banner advert to show to the client, or may contact an ad server 140 (see FIG. 1A) to perform this task. The ad server 140 may then select a banner advert to provide on the page according to various criteria, such as the subject matter of the requested page, the level of payment that the ad server is receiving in respect of any given banner material, and so on.

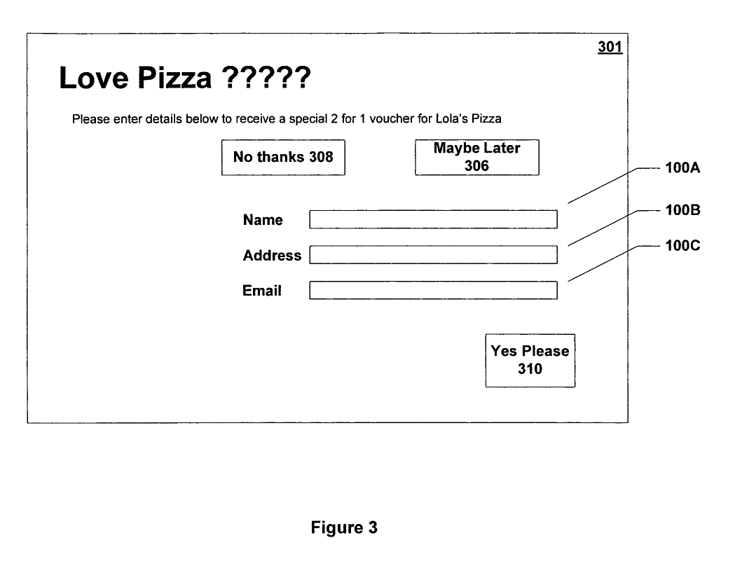

FIG. 3 illustrates one example of a form that it includes entry fields 100A, 100B, 100C for the name, address and email of the user. The form also includes an advertising message for a pizza firm. The message indicates that if the user completes the form, he/she will receive a special offer coupon from the pizza firm. The form may be provided to a user as an interstitial page at operation 210 in FIG. 2, or as a banner at operation 270 in FIG. 2A. A further possibility is that the form of FIG. 3 is accessed by the user activating a link from the interstitial page or banner.

The form includes three entry buttons, a No Thanks button 308, a Yes Please button 310, and a Maybe Later button 306. The No Thanks button will generally be selected by the user if they are not interested in the advertised offer, and so represents a negative response. Alternatively, the Yes Please button will generally be selected by the user if they are indeed interested in the advertised offer, and so represents a positive response. The third button, Maybe Later 306, indicates that the user has some interest in the offer, but does not want to proceed at present. It is expected that a user who selects the No Thanks button will not have completed the entry fields, whereas a user who selects the Yes Please button will have completed the entry fields. If a user who selects the No Thanks button has in fact completed one or more entry fields, these may be discarded, or the user may be prompted to confirm whether or not they want to sign up for the offer. If a user who selects the Submit button has not completed the entry fields, then an error message can be displayed informing the user that they need to provide the requested information in order to obtain the offer (the omitted field(s) may also be highlighted).

The form of FIG. 3 is primarily intended for marketing or advertising purposes. However, such a form can also be used more generally to acquire user data, for example for a wide variety of survey or polling purposes. The interstitial page or banner presenting the form can include any appropriate material in addition to the user data entry fields, such as text, images, animation, sound, and so on.

The use of the form of FIG. 3 can provide an advertiser with high quality leads. In other words, if a user is prepared to complete the entries fields 100A, 100B, 100C, this generally indicates a significant level of interest. In addition, the user contact information (as entered in the example of FIG. 3) allows the advertiser to pursue the lead proactively in the future, rather than having to wait for any further customer activity.

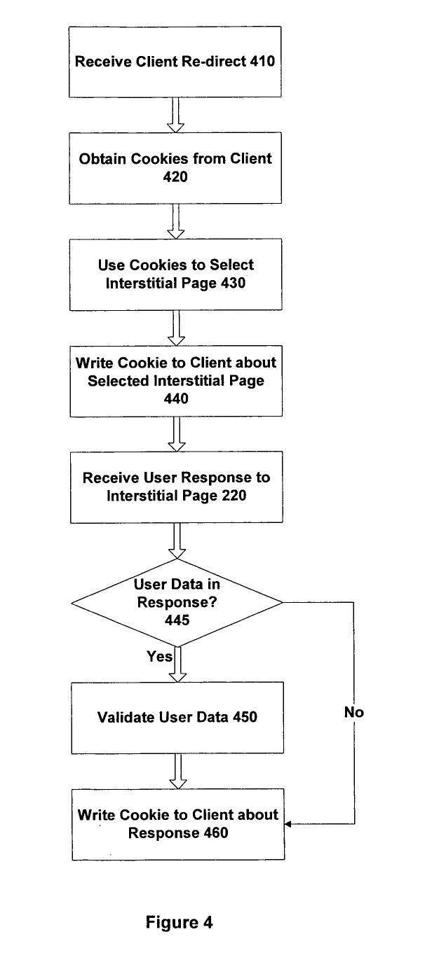

FIG. 4 illustrates the handling of client cookies by the Lola server 80 in accordance with one embodiment of the invention. In the embodiment of FIG. 4, the Lola server 80 is used to serve an interstitial page to a client, as per the method of FIG. 2. However, the handling of client cookies is also similar if the Lola server is used to provide a banner advertisement to the client, as per the method of FIG. 2A.

The method of FIG. 4 starts at operation 410 when the Lola server 80 receives a browser re-direct for a client 122 from a publisher web-site 130. At operation 420, the Lola server contacts the client to determine whether the client has any cookies previously stored on the client by the Lola server. The received cookie information can be saved to Lola database 70 if so desired. At operation 430, the Lola server uses the cookie information (if any) obtained from the client to determine which interstitial page to provide to the client.

At operation 440, when the interstitial page is provided to the client (corresponding to operation 210 in FIG. 2), the Lola server also stores a cookie on the client machine. The cookie records the identity of the interstitial page that is provided to the client. At operation 220 (as per FIG. 2), the user response to the interstitial page (or to a link generated from the interstitial page) is received by the Lola server. If the user response includes user data, as determined at operation 445, the user data is validated at operation 450.

The Lola server now writes a further cookie onto the client system at operation 460, for example as part of a thank-you or confirmation page. The further cookie indicates whether or not the user has returned user data that passed the validation at operation 450. The cookie written at operation 460 may also distinguish between whether (i) no user data has been received, or (ii) the user response included user data but this user data has failed the validation. The client can now be re-directed by the Lola server 80 back to the initial publisher web-site 130 to provide the client with the originally requested page (as per operation 230 of FIG. 2).

When a given client interacts with the Lola server 80 for the first time, the request of operation 420 will not yield any cookies. Nevertheless, the Lola server 80 will store cookies back to the client at operations 430 and 460. These cookies are then available for retrieval during subsequent interactions between the client and the Lola server. Consequently, when a client is re-directed to the Lola server, the Lola server can determine from the cookies stored on the client which interstitial pages 301 have previously been provided to the client, and also the user response to those pages. This information can then be used in selecting which particular advert or interstitial page to provide to the client.

In some implementations, if the user validation fails at operation 450, the Lola server may send a message to the client machine 122 drawing attention to the failure of the user data (and potentially indicating which field or fields are incorrect). This then provides the user with an additional opportunity to pass the validation operation 450. The user may be provided with multiple such opportunities if so desired. For example, processing might only pass from operation 450 to operation 460 once the user has provided data that passes the validation operation 450 (or after a predetermined number of failed attempts have been made).

Although FIG. 4 illustrates the provision of cookies when the Lola server injects an interstitial page to the client, a generally similar approach can be employed with a banner advertisement instead. In other words, the banner advertisement is provided to the client and a user response is received in return in conjunction with user data. The user data in this response can then be validated prior to writing a cookie back to the client machine, where the cookie indicates (at least) whether or not the received user data passed the validation.

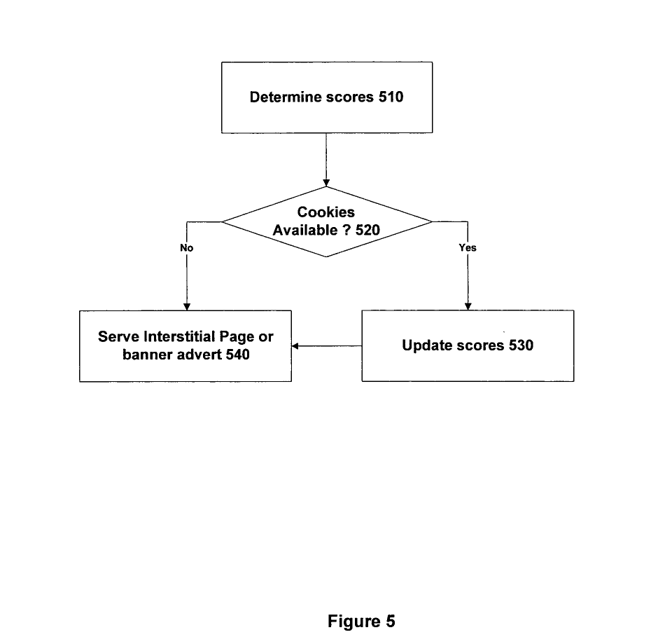

FIG. 5 provides a flowchart of the procedure used by the Lola server 80 for using cookie information to select which interstitial page or banner advertisement to serve to a client in accordance with one embodiment of the invention. The selection of FIG. 5 is based on a scoring algorithm, although other embodiments may use a different approach.

The flowchart of FIG. 5 commences with determining a score for each potential interstitial page or banner advert (operation 510). The score might be determined from one or more factors, such as yield, the web page being visited by the client, and so on. If no particular information is available about a particular client, the determination might be based on average performance or market norms. It is now determined (operation 520) whether any cookies have been retrieved from the client (as per operation 420 of FIG. 4). If so, the previously determined scores are updated based on the cookie information (operation 530). The best scoring page or advert can now be served to the client (operation 540).

As an example of the use of cookie information to update scoring information, if there has been a positive response previously to a particular advert, this may increase the desirability of repeating the advert to the user. For example, if a client has subscribed to the pizza voucher offer shown in FIG. 3, the advertiser may be happy to target further voucher offers at this user—whether repeats of the original offer or some new offer.

The influence of previous responses on the scores may be time-dependent. For example, if a user has recently specifically declined interest in a particular advert, it may not make sense to show them that advert again in the immediate future. In other words, this negative response will reduce the score for the advert (interstitial page) concerned. However, this reduction in score may decrease with time. Consequently, if a user was shown (and declined) an advert, then after a sufficient passage of time, e.g. many months, this circumstance would no longer count (or count strongly) against the selection of this advert to show again to the user.

One possibility is that if a user has previously (recently) rejected a particular interstitial page or banner, the next time that the user accesses the Lola server, an improved version of the same offer is provided to the user. For example, analogous to the interstitial page shown in FIG. 3, an initial version of a page might provide a £2 money off voucher. If the user does not accept this offer, the next time that the user is provided with the page, the offer might be increased to a £3 money off voucher. A user might therefore receive a sequentially improving set of offers.

The Lola server 80 is also able to tell from the received cookie whether or not the user provided data that passed the validation and this may influence the further actions of the Lola server. For example, if the user data is found to be invalid or otherwise unusable, the Lola server 80 may select an interstitial page or banner advert to display to the user that does not try to collect user data (but that rather provides revenue on a pay-per-click or pay-per-view basis for the operator of the Lola server). Alternatively, the Lola server may decide to re-serve the relevant page or banner advertisement to the user to have another go at collecting valid user data from the user (since no such valid data has been collected so far from the user).

In the embodiment of FIG. 1, the Lola server 80 (and database 70) receives re-directs from multiple publishing web-sites. The transactional history used when making the determination of which advert to show (based on previous responses) is effective across all these publishing web-sites. In other words, if a user accessing publisher web-site 130A declines a particular advert from the Lola server 80, and is subsequently re-directed to Lola server from publisher web-site 130B, the Lola system knows about the prior interaction with the user, and can factor this into the decision as to which interstitial page to provide to the client.

Accordingly, if a user has already provided a definitive response to a particular advert from a first publisher site (e.g. by expressing zero interest, or by expressing positive interest and providing contact details) the Lola system can determine a different advert to provide to the user. This is attractive for a user, in that they do not have their time wasted with irrelevant or inappropriate material; instead, the system of multiple publishers operates as a coherent (and more intelligent) whole. The arrangement is also attractive for advertisers in that they do not (unknowingly) repeat the same advert multiple times to the same client. This improves advertising efficiency and also reduces costs (as well as avoiding the risk of the client becoming disgruntled with the advertiser).

In the configurations so far described, the user selects a publisher web-site 130, but the cookies are provided by the Lola server 80. Since the user has not explicitly accessed the Lola server 80, these cookies are regarded as third party cookies, compared to cookies from the publisher web-site, which are second party cookies (since this party is directly known to the client). There is an increased likelihood of third party cookies being deleted from a machine, whether through ad hoc review by a user, or automatically, based on security settings of the machines.

Accordingly, one embodiment of the invention adopts an approach based on second party cookies from the publisher web-site. There are various ways in which this can be implemented. For example, rather than the Lola server writing cookies itself back to the client, the Lola server could request the publisher server 130 to which the client is re-directed to write the cookies (as part of operation 230).

In order for these cookies to be available when the user accesses other publisher web-sites, the screen 301 of FIG. 3 could be made to incorporate small components from the different publisher web-sites (these components may be transparent to the user, background objects or text etc). As each publisher web-site is contacted in relation to its respective component(s), the publisher web-site reads any second party cookies stored on the client machine from that particular publisher web-site. This information is then passed to the Lola server for use in determining which interstitial page to serve to the client.

As described above, the user information obtained via the screen 301 of FIG. 3 can be used to determine a cookie to provide to the user, as well as an interstitial page or banner advert to provide the user in the future. The user information obtained via the screen 301 of FIG. 3 also has value in its own right, as a set of lead generation data. For example, such lead generation data may be provided (sold) to a third party such as an advertiser. (The user information may also be collected for other purposes, including polling, surveys, etc.).

The real-time validation of the user information at operation 450 produces higher quality leads, in that (at least some) inaccurate, spurious, or phoney leads are eliminated from the user data set. As a result, the advertiser or other recipient of the user data set obtains a high quality, validated data set. This can then help to ensure (for example) that money on follow-up mailings is not wasted in respect of people or addresses that do not actually exist, or who have no genuine interest in the relevant offering.

Although the implementation shown above in FIG. 4 involves the Lola server performing both the provision of the injected material (e.g. banner ad or interstitial page) and also the validation of the user input, in many implementations these roles may be separated. In such implementations, for example, an ad server may select which material to inject for the user. This injected material may lead directly or indirectly to a user form such as shown in FIG. 3, whereby a user enters data into a form or such-like. The data from this form is then returned to the Lola server 80 for validation as described above in relation to FIG. 4 (and also as described further below).

With reference to operation 460 of FIG. 4, when the Lola server provides a thank-you or confirmation page for the user data, it is able to write not only its own cookies to the client, but also those for other parties. For example, the confirmation page may include a reference (invisible to the user) to the ad server 140, thereby enabling the ad server to drop its own cookies onto the client machine. These cookies can then be accessed by the ad server the next time it has to provide injected material for the client (corresponding to operation 420 in FIG. 4), and can then help the ad server to determine what material should be provided to the client (corresponding to operation 430 in FIG. 4, and analogous to the processing of FIG. 5).

The ability of the ad server cookies to piggy-back, in effect, on the confirmation page from the Lola server 80 can be considered as a form of pre-duplication avoidance. Consider, for example, the situation where an ad server is handling an advertising campaign that is being run through multiple publisher web-sites. If material injected by the ad server for one of these web-sites ends up with a validated set of user data for a particular client, then the Lola server will enable the ad server to write a cookie onto that client. The next time that the ad server comes into contact with that client, via any of the multiple publisher web-sites, the ad server knows that this client has already provided valid user data for this particular injected material and accordingly is able to make a different choice of injected material.

This facility is attractive to advertisers and other collectors of user data because once a person has already provided valid user data, the advertiser will not end up paying for any data submissions from the user (or visits to the data collection web-site, depending on the relevant arrangements). The advertiser is also able to avoid the risk of annoying a user by continuing to send them injected material in relation to offers, surveys, etc to which the user has already responded.

In contrast, existing techniques provide only post-duplication, in that they can scan through data sets for user duplication only after the interaction with the user has finished (and when it is no longer possible to write a cookie back to the user machine). The post-duplication procedures are comparatively cumbersome (and also do not prevent further duplication in the future if the relevant campaign is still active).

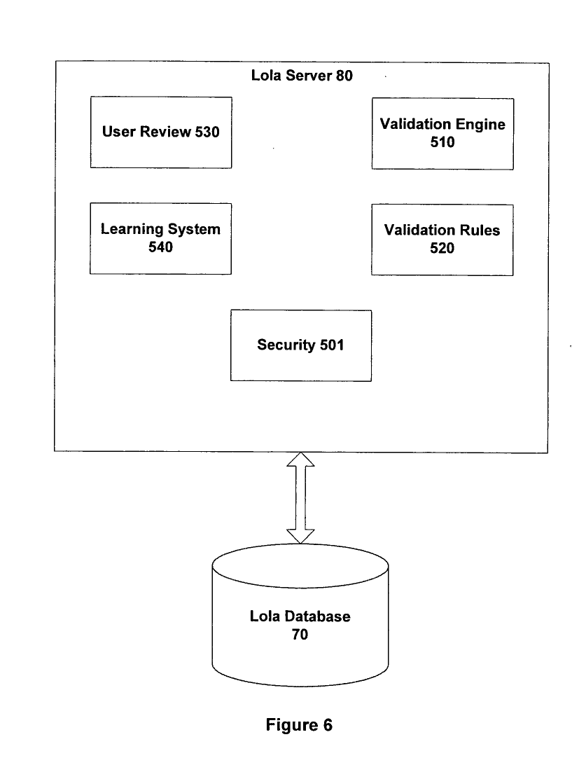

FIG. 6 is a diagram illustrating certain components involved in user validation according to one embodiment of the invention, especially in the context of lead generation and other such activities. These components are shown as being part of the Lola server 80, although they may be provided in one or more ancillary systems. Note that existing web forms frequently include some degree of validation on the user data, for example to check that all essential fields are completed, that a confirmed password matches the original password, or that a proposed travel date is not in the past. These predefined checks are generally made on the client itself as part of the form completion before returning the form to the server. In contrast, the validation as per operation 450 in FIG. 4 is performed by the server 80 rather than on the client. Furthermore, such checking is generally performed as part of the main application flow for the client. In contrast, the present approach relates to the processing of injected material such as banner adverts or interstitial pages. The handling of these is especially time-critical, because they may be seen as something of an imposition by the user and if they are too slow, the user might avoid the web-site for that publisher in the future.

The real-time validation is performed by validation engine 510 in accordance with stored validation rules 520. Examples of such rules are:

a) reject if known spurious names or addresses—e.g. Mickey Mouse, Luke Skywalker, Gotham City etc
b) reject if known expletives
c) reject if known artificial constructs—e.g. QWERTY
d) reject if form of address incorrect—e.g. post code (ZIP code) inconsistent with street/town
e) reject if form of phone number incorrect—e.g. wrong number of digits
f) reject if mismatch between address and phone number (if phone number is geographical number)

Note that much of this filtering is based on performing negative matching against data sets of known acceptable responses—i.e. reject the data input if there is a match. This is again different from many conventional transaction validations, which usually perform some form of positive matching, for example checking that a credit card number and an address match in order to confirm a transaction. In general, negative matching involves more overheads, both in terms of storage and processing capability. This is because the data input must be compared with a potentially large number of options.

As discussed above, if the validation fails, the client may be presented with an opportunity to re-enter the user information. Whether or not such an opportunity is provided may be dependent on the nature of the validation failure. For example, if the user information is rejected for containing expletives, then it may be decided that the client does not want to provide the relevant information, and hence there is no point presenting the user with another opportunity. On the other hand, if the phone number has an incorrect number of digits, this might just be a typing error by the user, and so it might be more appropriate to present the user with an opportunity to re-enter the data in such circumstances.

In some implementations, the validation engine may be able to perform a specific validation of the phone number. For example, the validation engine may maintain or be able to access in real-time a listing of active phone numbers. Another possibility is that the validation engine can confirm in real-time via a link to some third party system, for example a telephone exchange, that the specified telephone number is reachable (at least in theory). If the telephone exchange indicates that the specified telephone number is not reachable, then the user information is rejected and the validation fails.

The validation engine 510 can also detect other signs in the user information that may indicate spurious or falsified data. For example, the IP address from which the data is provided can often be tied to a geographical location (see for example www.quova.com) and this can be matched against the user address if so desired. The validation engine can also check whether multiple sets of user information are all being provided from a single IP address. Although it is possible with dynamic IP address allocation for two different users to make successive use of the same address, the validation engine may reject user data if a large number of inputs are received from a the same IP address, but purportedly from many different users. Such a situation may indicate that indicate that the user data is being generated and submitted automatically (by machine), perhaps to illicitly boost the apparent rate of lead collection.

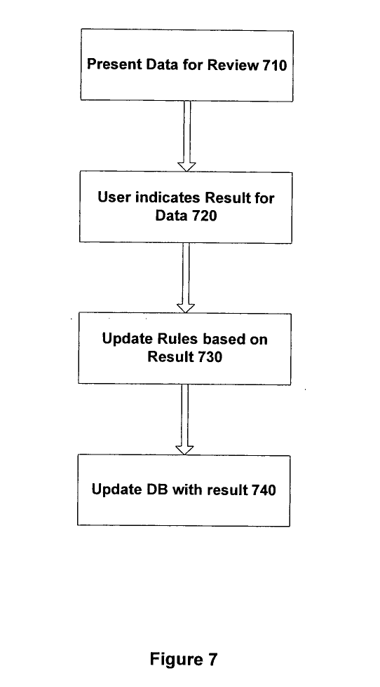

FIG. 7 is a flowchart for updating the validation system of FIG. 6 in accordance with one embodiment of the invention. In particular, the updating is based on a learning approach, where the validation system is provided with “correct” answers for validating certain data, and from this information improves and enhances the validation rules 520.

The method of FIG. 7 begins with the presentation of user data to a human for review (operation 710). In general it is not expected that this review is performed in real-time as per operation 450 in FIG. 4. Rather the review may be performed at some later time as part of a process for refining and improving the validation rules. For example, the Lola database 70 can be used to store all incoming user data, including an indication of whether or not a manual review has been performed. The review may just be limited to user data that passed the real-time validation of operation 450, or may also include some or all of the user data that failed the real-time validation.

The user review component 530 of the Lola server accesses the user data for review from the Lola database via a security layer 501. The security data restricts access to the user data in accordance with various data protection and privacy regulations. For example, security layer 501 may only permit a user to review a screen-full of user data at a time, rather than downloading a significant portion of the user data from database 70.

For each item of user data, the reviewer now indicates whether or not the user data should be rejected for validation (operation 710). This information is passed to a learning system 540, which uses the information to update the validation rules 520 applied by the validation engine 510, as per operation 730. There are various known types of learning system 540 that can be used in the Lola server, including a neural network, an expert system etc. The validation engine 510 can then use the updated validation rules 520 for the next real-time validation of user data as per operation 450. In other words, the real-time validation of user data is performed using a validation engine having a learning facility to update the validation engine automatically based on previous user data.

In some cases the validation engine may flag certain user data to the reviewer, especially if the validation engine is less certain about such user data. For example, the validation engine 510 may determine a validation score for a given set of user data, where the user data is rejected if the validation score is above a predetermined level. The user review system 530 may particularly present for review user data having a validation score close to this predetermined level, since this is generally the user data having the greatest uncertainty as to disposition. The user review system may also indicate a default (or actual) disposition for the user data (accept/reject), which the user can then override.

As an example of the learning approach, the user data may comprise the name “Gordon Brown” and the address “10 Downing Street”. The validation engine 510 may initially accept this user data, but a reviewer may subsequently mark the input as invalid (failing validation). This may cause the user review system 530 to flag any subsequent user input involving the name “Gordon Brown” or the address “10 Downing Street” for default rejection. However, a reviewer subsequently accepts user data having “Gordon Brown” as a name, but an address that is different from “10 Downing Street”, the learning system 540 will recognise that the rejection is primarily due to the address rather than the name and can update the validation rules 520 accordingly.

There are various parties who could be responsible for the performing the review of the validation system. One possibility is for the review to be performed by the advertiser or other party that is paying for the lead generation. In this arrangement, the advertiser can ensure that they only pay for bona fide leads. Although this can then translate into less revenue for the operator of the Lola server, they will end up with an improved validation system with updated validation rules. This may then allow them to charge a higher rate for future lead generation, since the validation of the leads will be more refined and accurate.

The validation review of the user data set might be performed instead (or as well) by the operator of the publisher web-site 130, especially if they are receiving compensation based on the number of leads produced from their web pages. This would then allow them to audit the validation process to ensure that the validation engine 510 is not over-aggressive in rejecting the user data (which would then reduce the publisher revenue).

In some embodiments, the user data set may be subject to multiple reviews, for example from one or more different advertisers and/or one or more different publishers. Note that the same filtering rules may be applied across many different types of advert or other injected content, so that there is mutual development and enhancement involving many different parties. This allows the filtering rules to be developed much more efficiently.

Although the validation system and method of FIGS. 6 and 7 have primarily been described in the context of lead generation, especially for advertising and sales, they may also be used for collecting user data for a much wider range of purposes. For example, the validation system and method may be utilised when collecting user data for on-line surveys or on-line voting, when collecting campaign donations for political organisations (to ensure that the donor is properly identified), for performing user identification to combat fraud, money laundering, and so on.

In conclusion, a variety of particular embodiments have been described in detail herein, but it will be appreciated that this is by way of exemplification only. The skilled person will be aware of many further potential modifications and adaptations that fall within the scope of the claimed invention and its equivalents.

1-24. (canceled)

25. A method for a server to interact with a user machine over a network, the method comprising the server:
receiving user information from the user machine in response to injected content received by said user machine;
validating the user information in real-time to produce a validation result; and
writing a cookie to the user machine as part of a confirmation page for the user information, said cookie indicating said validation result.

26. The method of claim 25, wherein said injected content comprises a banner ad.

27. The method of claim 25, wherein said injected content comprises an interstitial page.

28. The method of claim 25, wherein said injected content includes a form for allowing a user to enter the user information.

29. The method of claim 25, wherein said injected content is linked to a form for allowing a user to enter the user information.

30. The method of claim 25, wherein the injected content is provided in response to a request for a specified page at a publisher web-site.

31. The method of claim 25, wherein said validation result cookie is obtained prior to providing the user machine with further injected content.

32. The method of claim 25, wherein said confirmation page allows an ad server to write a cookie to the user machine, said ad server cookie indicating the validation result.

33. The method of claim 32, wherein said ad server cookie is obtained by the ad server prior to supplying further injected content to the user machine and used to determine which further injected content to supply to the user machine.

34. The method of claim 33, wherein in response to obtaining a particular validation result cookie from a user machine, ad server does not provide the user machine with the injected content that led to said validation result cookie.

35. The method of claim 25, wherein the validation result cookie further indicates the injected content received by the user machine.

36. The method of claim 25, wherein if validating the user information in real-time produces a negative validation result, prompting the user machine to provide amended user information.

37. The method of claim 36, further comprising validating the amended user information in real-time to produce an updated validation result, and wherein the cookie written to the user machine indicates said updated validation result.

38. The method of claim 25, wherein said validation involves screening the user information against multiple data values for a negative match.

39. A method for pre-duplication avoidance comprising:
receiving user information from the user machine in response to injected content received by said user machine;
validating the user information in real-time to produce a validation result;
writing an ad server cookie to the user machine as part of a confirmation page for the user information, said cookie indicating said validation result;
detecting said cookie at the user machine in the future by said ad server; and
using the detected cookie to determine further injected material to provide to the user machine.

40. A method comprising:
receiving a consumer data set over a network in response to injected content provided to the consumer;
scanning multiple aspects of the consumer data set to filter the data sets to produce a real time validation of these data set
placement of cookie on the consumer machine to reflect the outcome of the validation, wherein said cookie serves to avoid the consumer being asked again to provide the same data set.

41. The method of claim 40, wherein the filtering can be iteratively enhanced by manual input from multiple operators providing subsequent review of the received data sets.

42. A server for interacting with a user machine over a network, the server including one or more processors configured to execute instructions to perform the method of:
receiving user information from the user machine in response to injected content received by said user machine;
validating the user information in real-time to produce a validation result; and
writing a cookie to the user machine as part of a confirmation page for the user information, said cookie indicating said validation result.

43. A computer program product comprising program instructions on a storage medium, the instructions when loaded into a computer system for execution by one or more processors of the computer system causing the computer system to implement the method of:
receiving user information from the user machine in response to injected content received by said user machine;
validating the user information in real-time to produce a validation result; and
writing a cookie to the user machine as part of a confirmation page for the user information, said cookie indicating said validation result.
